(19) United States
(12) Patent Application Publication
(10) Pub. No.: US 2026/0244372 A1
(43) Pub. Date: Aug. 20, 2026

(54) CONTROL METHOD FOR AN INFORMATION PROCESSING APPARATUS AND METHOD, INFORMATION PROCESSING APPARATUS AND MEDIUM

(71) Applicant: CANON KABUSHIKI KAISHA, Tokyo (JP)

(72) Inventors: TOMOYA KOBAYAKAWA, Kanagawa (JP); TAKUYA TAKEUCHI, Saitama (JP)

(21) Appl. No.: 19/536,463

(22) Filed: Feb. 11, 2026

(30) Foreign Application Priority Data
Feb. 14, 2025 (JP) 2025-022493

(51) Int. Cl. G06F 3/12; H04W 28/04; H04W 84/12

(52) U.S. Cl. CPC G06F 3/121; G06F 3/1236; G06F 3/1292; H04W 28/04; H04W 84/12

(57) ABSTRACT

A control method for an information processing apparatus includes determining whether an error has occurred in communication between the information processing apparatus and a communication apparatus, and executing predetermined processing for causing the information processing apparatus to start an operation as a first access point based on a determination that an error has occurred in the communication.

### BACKGROUND

### FIELD OF THE TECHNOLOGY

The technology of the present disclosure relates to a method for controlling an information processing apparatus, an information processing apparatus and a medium.

### DESCRIPTION OF THE RELATED ART

Methods for performing communication between a printer and an information processing apparatus include a wireless communication method using a wireless local area network (called a wireless LAN), in particular, Wi-Fi (registered trademark). The wireless communication method using Wi-Fi is roughly divided into two systems. The first system is a system in which the printer and the information processing apparatus communicate with each other by connecting peer-to-peer by a wireless LAN. The second system is a system in which the printer and the information processing apparatus communicate with each other via an access point by the printer and the information processing apparatus being connected to an access point by a wireless LAN. The first system may be called a peer-to-peer mode or a P2P mode, and the second system may be called an infrastructure mode. Recently, not only printers but also various apparatuses perform communication using Wi-Fi, and therefore, considering a case where an information processing apparatus only includes one wireless LAN interface, a system that can communicate with a plurality of apparatuses via an access point is desirable. For this purpose, since a setting for connecting the printer to the access point is necessary, a technology for transmitting wireless setting information stored in the information processing apparatus to the printer so as to be easily settable and performing wireless setting of the printer is known in Japanese Patent Laid-Open No. 2018-191252.

However, in a case where a network is configured via the access point as described above, wireless communication between the printer and the access point may be lost due to insufficient radio field intensity. The insufficient radio field intensity may occur when a physical distance to the access point is long or when close frequency bands as in the case of a microwave oven interfere with each other. By this, there is a problem that printing cannot be performed because connection between the printer and the access point is lost even when the information processing apparatus transmits a print command or the like to the printer via the access point.

### SUMMARY

The technology of the present disclosure recovers the connection to the communication apparatus without resetting the communication apparatus by a user even in a case where the connection between the communication apparatus such as the printer and the access point is lost.

According to one aspect of the present disclosure, a control method for an information processing apparatus, the control method comprising: determining whether an error has occurred in communication between the information processing apparatus and a communication apparatus; and executing predetermined processing for causing the information processing apparatus to start an operation as a first access point based on a determination that an error has occurred in the communication is provided.

The above configuration can recover the connection to the communication apparatus without resetting the communication apparatus by a user even in a case where the connection between the communication apparatus such as the printer and the access point is lost.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1A is a configuration diagram of the present system. FIG. 1B is another configuration diagram of the present system. FIG. 2 is a hardware configuration diagram of an information processing apparatus and a printer. FIG. 3 is a software configuration diagram of the information processing apparatus. FIG. 4 is a sequence diagram of wireless connection recovery at the time of a wireless communication error of a printer using an AP mode of the information processing apparatus of the present system. FIG. 5 is a sequence diagram of wireless connection recovery in the case where the information processing apparatus of the present system is using the AP mode. FIG. 6 is a flowchart when an application of the present system determines whether the AP mode can be enabled. FIG. 7 is a sequence diagram for performing setting of an AP in a printer via temporary connection using the AP mode when communication between the information processing apparatus and the printer is no longer possible due to replacement of the AP in the present system or the like.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### System Configuration

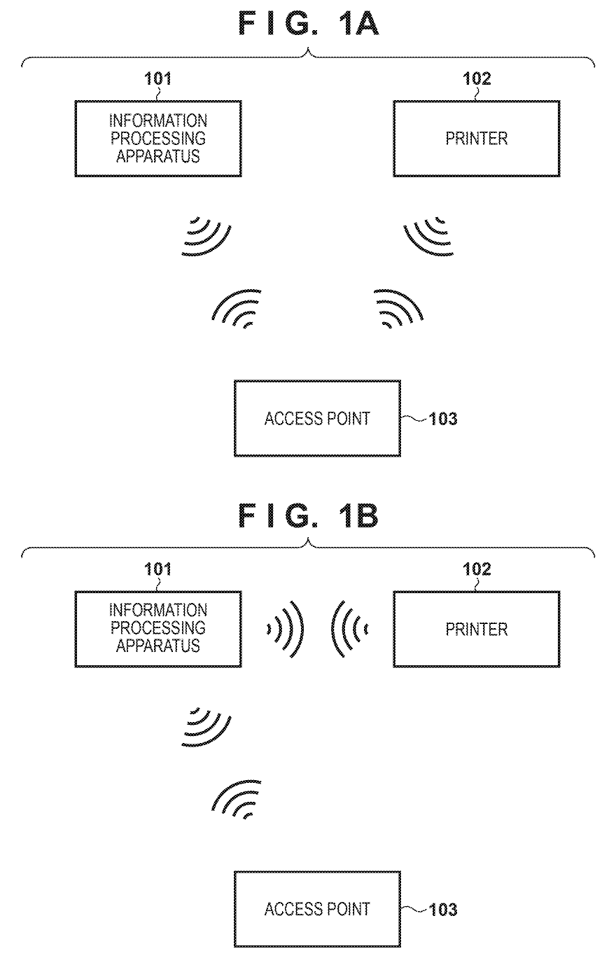

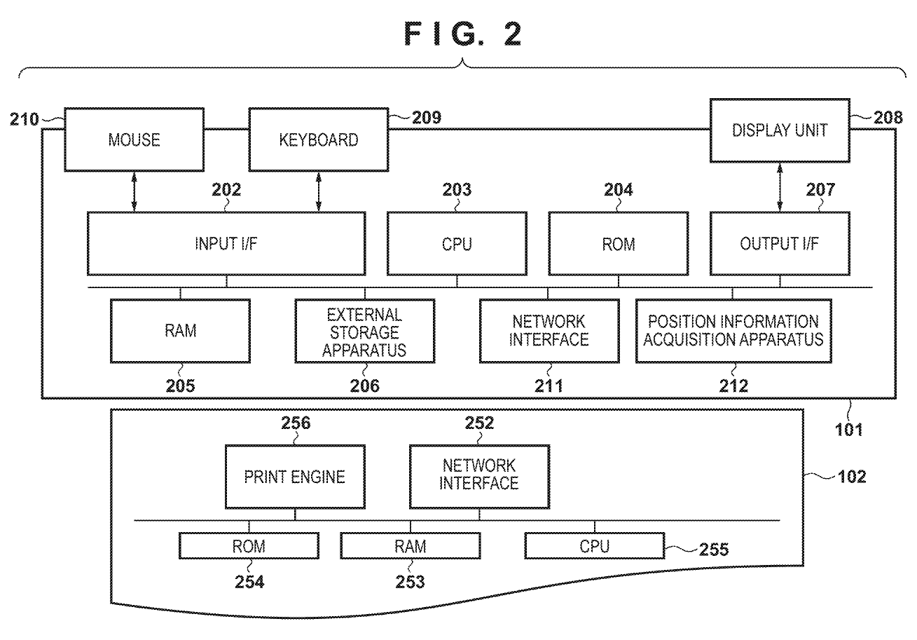

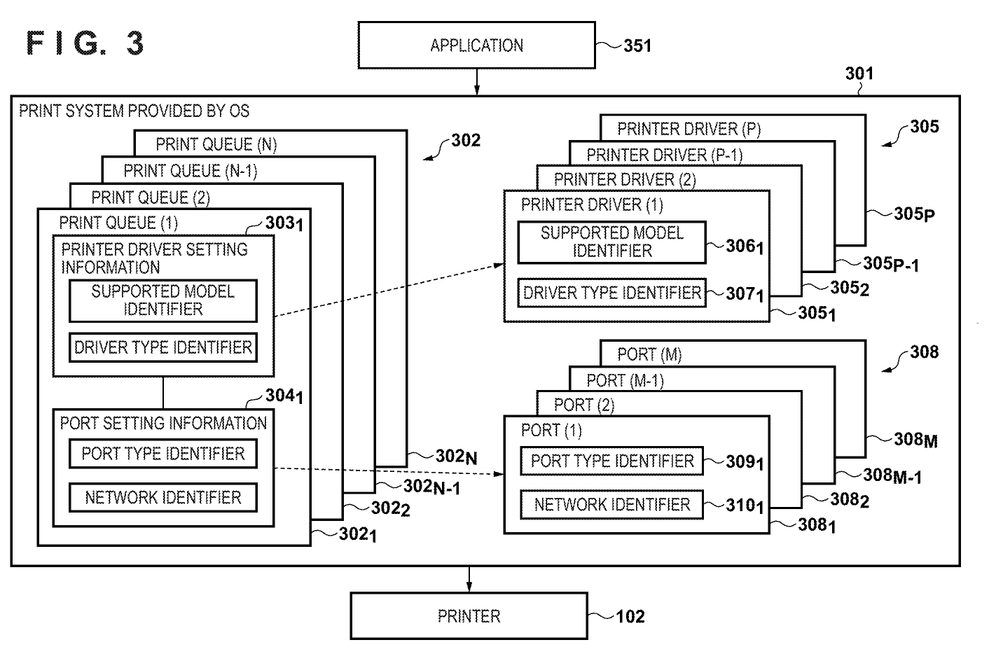

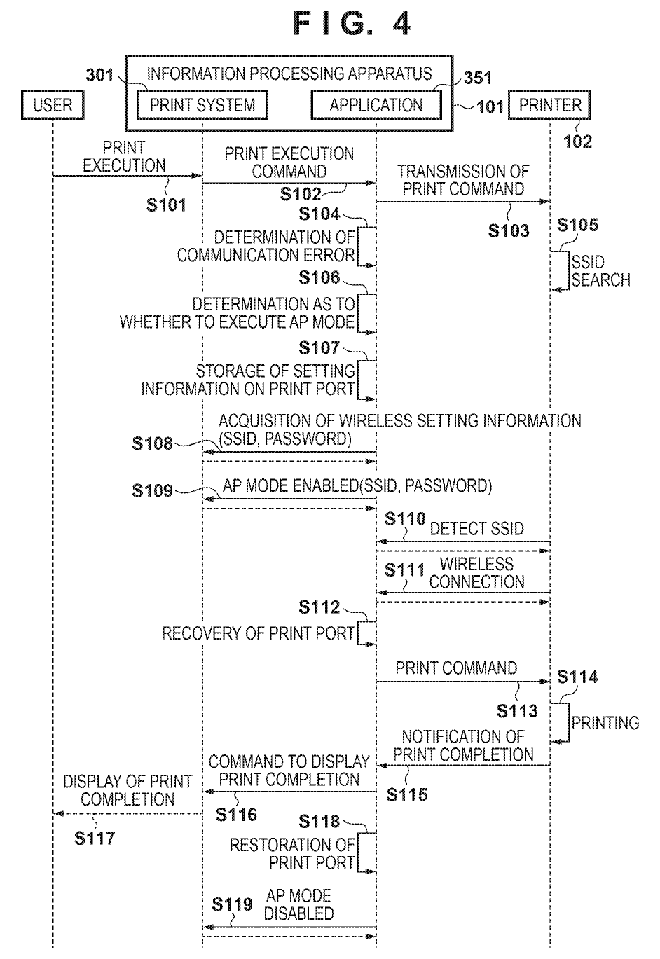

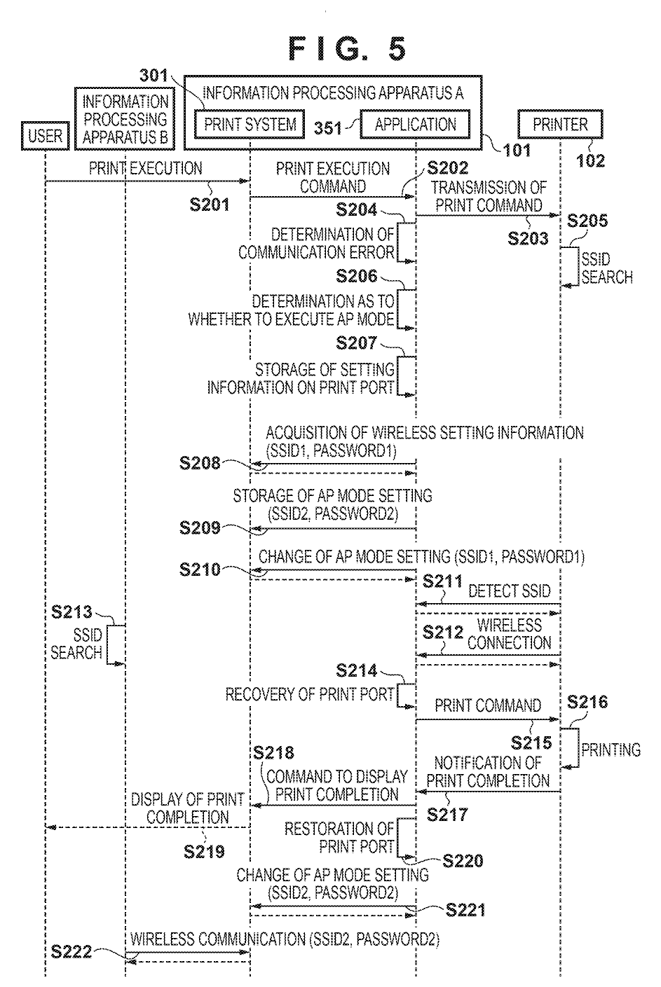

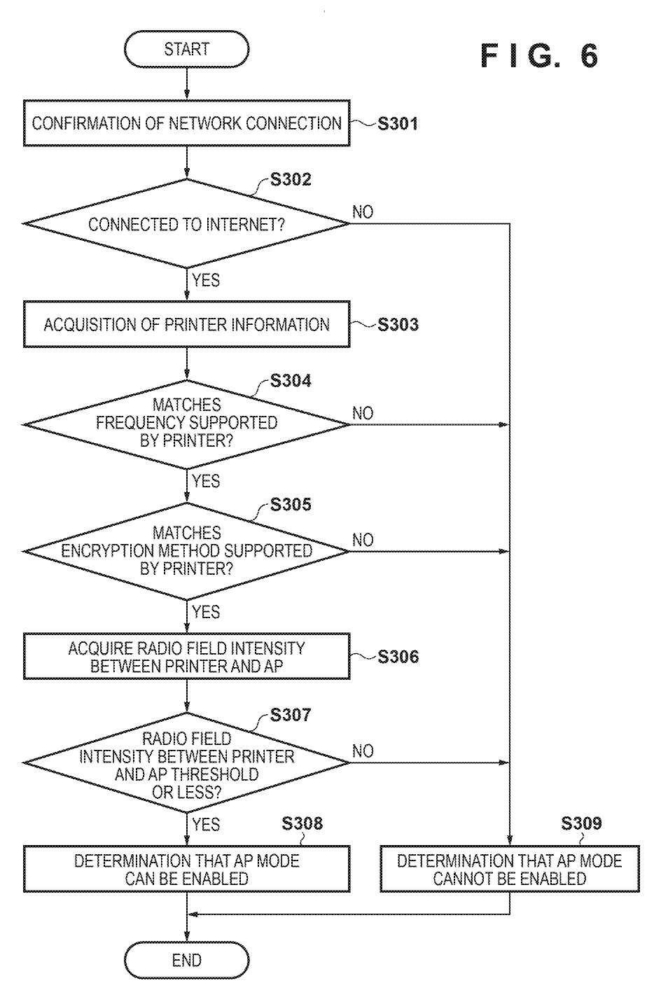

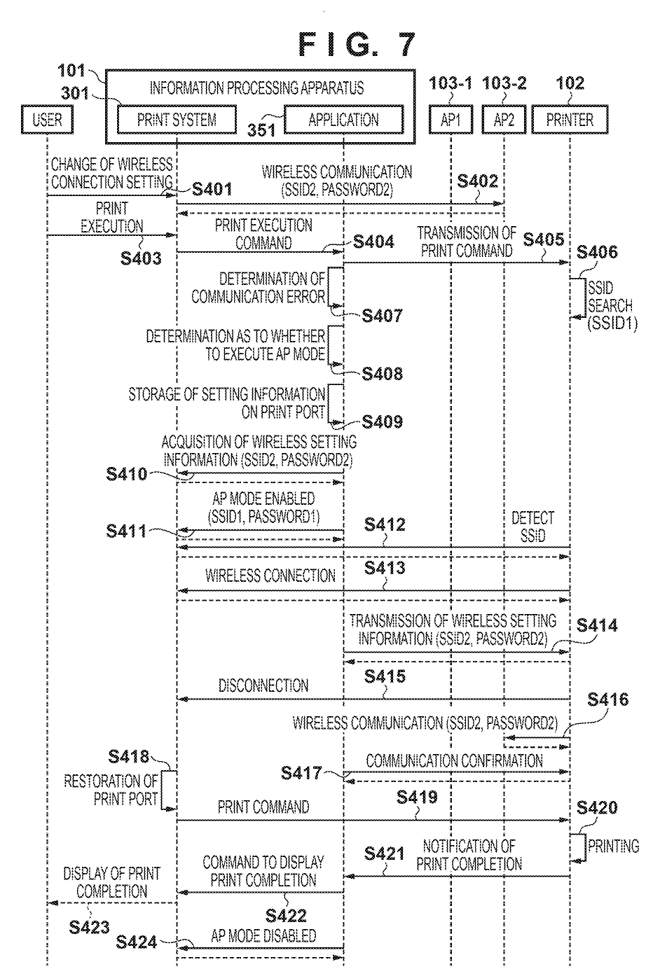

A configuration of the present system will be described with reference to FIGS. 1A and 1B. FIG. 1A is a communication system including an information processing apparatus 101, a printer 102, which is a communication apparatus, and an access point (AP) 103. In this communication system, the information processing apparatus 101 and the printer 102 are wirelessly connected by a wireless LAN via the AP 103. In the present embodiment, it is assumed that this wireless connection uses Wi-Fi. Therefore, the information processing apparatus 101 can communicate with the printer 102 via the AP 103. The information processing apparatus 101 executes an application (application 351 in FIG. 3) to transmit a print command and the like to the printer 102. The application 351 is installed in the information processing apparatus 101 by an [0] installer or the like. When the application 351 is installed, a print port for communicating with the printer 102 is created in the information processing apparatus 101. The application 351 transmits the print command to the printer 102 using the print port. This enables the printer 102 to execute printing from the received print command.

Here, a configuration diagram when direct wireless connection between the information processing apparatus 101 and the printer 102 according to the present embodiment is executed when the wireless communication between the printer 102 and the AP 103 is lost is FIG. 1B. The information processing apparatus 101 is in a state of being wirelessly connected to the AP 103 and is assumed to operate as an access point of a wireless LAN. In order to implement this assumption, for example, if the information processing apparatus 101 is a computer equipped with a Windows (registered trademark) OS with version 10 or later, a mobile hotspot function provided by the OS may be used. By causing SoftAP, which is a virtual Wi-Fi adapter, to function, the mobile hotspot function of Windows can simultaneously implement, by one wireless LAN interface, connection with the AP 103 and connection with the slave station as an AP. If the information processing apparatus 101 includes a plurality of wireless LAN interfaces, different wireless LAN interfaces may be used. Note that an operation mode in which the information processing apparatus 101 operates as an access point of the wireless LAN is called an AP mode. In the AP mode, for example, a tethering function or the like is implemented. A function that achieves an AP by the information processing apparatus 101 such as SoftAP may be called a virtual access point function (virtual AP function) or simply an access point function, and an AP implemented by the virtual AP function may be called a virtual access point (virtual AP). By connecting the printer 102 to the information processing apparatus 101 in the AP mode, the information processing apparatus 101 and the printer 102 communicate with each other peer-to-peer, and therefore it is possible to directly transmit a print command or the like. Wireless setting information on the printer 102 can be corrected as necessary. A series of processing operations in FIGS. 1A to 1B will be described in the embodiment described later.

A hardware configuration diagram of each of the information processing apparatus 101 and the printer 102 will be described with reference to FIG. 2. The information processing apparatus 101 may be, for example, a general-purpose computer, a smartphone, a tablet terminal, or the like. The information processing apparatus 101 includes an input interface (I/F) 202, a CPU 203, a ROM 204, a RAM 205, an external storage apparatus 206, and an output interface (I/F) 207. The information processing apparatus 101 further includes a display unit 208, a keyboard 209, a mouse 210, a network interface 211, and a position information acquisition apparatus 212. The ROM 204 contains an initialization program, and the external storage apparatus 206 stores an application program group, an operating system (OS), a printer driver, and various other data. The RAM 205 is used as a work memory by various programs stored in the external storage apparatus 206. A program such as an application program is loaded into the RAM 205 and executed by the CPU 203. Hereinafter, a form in which Windows (registered trademark) of Microsoft Corporation is used as the OS will be described as an example.

The network interface 211 controls wireless communication and communication processing via a wired LAN cable. In the present embodiment, the network interface 211 of the information processing apparatus 101 may include at least one wireless LAN interface. The position information acquisition apparatus 212 acquires position information of the information processing apparatus 101. The position information acquisition apparatus 212 may be a satellite positioning system such as a global positioning system. The information processing apparatus 101 operates as a slave station with respect to the AP 103, and is operable in the AP mode that functions as an AP by software.

The printer 102 may be, for example, a single-function printer or a multifunction peripheral having other functions such as a scanner, but here, a single-function printer is given as an example. The printer 102 includes a network interface (I/F) 252, a RAM 253, a ROM 254, a CPU 255, and a print engine 256. The network interface 252 controls wireless communication and communication processing via a wired LAN cable. In the present embodiment, the network interface 252 of the printer 102 may include at least one wireless LAN interface. The RAM 253 is used as a main memory and a work memory of the CPU 255, and stores a reception buffer for temporarily storing received print command, print data and various data. The print engine 256 performs printing based on the data stored in the RAM 253. The ROM 254 contains various control programs and data to be used by each control program, and the CPU 255 controls each unit of the printer 102 according to these control programs. Here, as an example, the processing sharing between the information processing apparatus 101 and the printer 102 has been described above, but the present disclosure is not particularly limited to this sharing form, and other forms may be used.

A software configuration of the information processing apparatus 101 will be described with reference to FIG. 3. The information processing apparatus 101 includes the application program 351 (hereinafter, abbreviated as the application 351) executable in the information processing apparatus 101. The application 351 can cause the printer 102 to execute printing via a print system 301 provided by the OS. The application 351 is also software that can recover the transmission destination port setting of a print queue in which transmission of print data to the printer 102 is disabled due to incorrect transmission destination port setting. The application 351 can also change the network setting such as setting the information processing apparatus 101 to the AP mode using the network interface 211 of the information processing apparatus 101. The application 351 inquires about a print queue 302 that is available for transmitting print data via the print system 301 provided by the OS, and, based on the result of the inquiry, accesses an appropriate print queue 302n (n is any of 1 to N). The application 351 inquires about a printer driver 305 that is available via the print system 301, and, based on the result of the inquiry, accesses an appropriate printer driver 305p (p is any of 1 to P).

The printer driver 305p includes, as identifiers, a supported model identifier 306p including a type name or a model name of the printer 102, and a driver type identifier 307p such as GDI, XPS, and FAX. The application 351 inquires about a port 308 that is available via the print system 301, and, based on the result of the inquiry, accesses an appropriate port 308m (m is any of 1 to M). The port 308m includes a port type identifier 309m such as USB, TCP/IP, or WSD, and a network identifier 310m such as an IP address or a host name. Each print queue 302n (n is any of 1 to N)) is associated with the printer driver 305p and the port 308m. The print queue 302n includes printer driver setting information 303n for specifying the associated printer driver and port setting information 304n. The printer driver setting information 303n includes printer driver reference information including the supported model identifier and the driver type identifier for identifying the printer driver. The port setting information 304n includes port reference information including a port type identifier and a network identifier for identifying the port. For example, the port setting information on the print port includes an IP address, a port name, and a printer name of the printer 102. Here, the application 351 is configured to be responsible for printing and detection of a communication error, recovery of the transmission destination port setting of a print queue, and change of the network setting, but these may be configured as different applications. For example, the printer driver 305 may be configured to detect a communication error at the time of print execution and instruct another application to recover the transmission destination port setting of the print queue, thereby executing recovery of the port setting and change of the network setting.

The embodiment of the present system will be described with the above configuration. In each embodiment, communication and processing are performed in the communication system having the above configuration.

### First Embodiment

FIG. 4 is a sequence diagram of wireless connection recovery at the time of a wireless communication error of a printer using an AP mode of the information processing apparatus of the present system. As in FIG. 1A described above, it is assumed that the AP 103 establishes communication with each of the information processing apparatus 101 and the printer 102, and the printer 102 is brought into a wireless communication error state with respect to the AP 103. Examples of cause of the wireless communication error state include insufficient radio field intensity. In FIG. 4, the information processing apparatus 101 is divided into the operation of the application 351 and the print system 301, but the operation is implemented by the CPU 203 executing a program. Therefore, the CPU 203 is the hardware entity in the process whose execution entity is the application 351 or the print system 301, and the CPU 255 is the entity in the configuration whose execution entity is the printer 102. Note that for simplification of illustration, the print system 301 illustrated in FIG. 4 includes not only the configuration illustrated in FIG. 3 but also functions other than the application 351 provided by the OS for performing setting change according to the user operation and processing regarding wireless communication. Therefore, even the process illustrated with the print system 301 as the entity includes a process in which an OS function or a device driver other than the print system 301 is involved. The same applies to FIGS. 5 and 7.

In S101, the user inputs an operation for executing printing from the keyboard 209 or the mouse 210 of the information processing apparatus 101. That is, inS101, the information processing apparatus 101 receives an input instructing printing by the user. In S102, the print system 301 of the information processing apparatus 101 transmits a print execution command to the application 351. In S103, the application 351 transmits, to the printer 102, the print command received in S102. This transmission is performed via the AP 103. In S104, the application 351 determines a communication error because no response from the printer 102 is returned for the print command ofS103. Here, the application 351 may set a certain waiting time, for example, and may determine that there is a communication error if there is no response within the waiting time from the transmission. For example, even in a case where there is no particular data to be transmitted/received between the information processing apparatus 101 and the printer 102, by performing transmission/reception of an alive confirmation signal at predetermined time intervals, it is possible to detect a communication error also in the printer 102 if there is no signal for more than a predetermined time, for example. Note that communication between the information processing apparatus 101 and the printer 102 is performed via the AP 103 if it is in the infrastructure mode.

On the other hand, in response to the occurrence of the wireless communication error in S103, the printer 102 performs in S105 an SSID search based on a service set identifier (hereinafter, SSID) of the AP 103 to which the printer 102 was connected. The SSID search is performed, for example, by receiving a beacon transmitted from the AP and determining whether the SSID included in the received beacon is the SSID of the AP 103. Unless the corresponding SSID is found, the printer 102 continues to execute the SSID search processing of S105. In S106, the application 351 determines whether to execute the AP mode. Whether or not to execute the AP mode is determined based on whether or not the virtual AP implemented by the AP mode can communicate with the printer 102. This determination as to whether to execute the AP mode will be described in detail with reference to the flowchart of FIG. 6. Here, it is assumed that the AP mode is determined to be executable. In a case where it is determined that the AP mode can be executed, that is, enabled, the processing is continued fromS107. In a case where it is determined that the AP mode cannot be executed, that is, cannot be enabled, the sequence of FIG. 4 is stopped there.

In S107, the application 351 stores, in the RAM 205 of the information processing apparatus 101, the setting information on the print port used at the time communication with the printer 102 via the AP 103 was possible. The setting information on the print port includes an IP address, a port name (or a port number), and a printer name of the printer 102, and is information for designating a path for transmitting data such as a print job to the printer. InS108, the application 351 acquires wireless setting information from the information processing apparatus 101. Here, the wireless setting information refers to information on the SSID and the password of the AP. The SSID and the password of the AP 103 are acquired in S108. In a case where the OS operating on the information processing apparatus 101 is Windows (registered trademark), the SSID and the encrypted password are stored in the ROM 204 of the information processing apparatus as a Wi-Fi profile. Therefore, the wireless setting information can be acquired by decrypting the encrypted password. In S109, the application 351 enables the AP mode of the information processing apparatus 101. Specifically, Windows is equipped with a tethering function, which is a function using a virtual wireless adapter called SoftAP, and can operate the information processing apparatus 101 as a virtual AP by executing the API of the OS for executing the tethering function. That is, the information processing apparatus 101 can cause itself to operate in the AP mode by the tethering function. Note that the information processing apparatus 101 may maintain the connection with the AP 103 via the wireless LAN in parallel with the operation as the virtual AP, or may disconnect the connection with the AP 103 via the wireless LAN to execute only the operation as the virtual AP. Since an OS other than Windows also includes the tethering function, in a case where the OS included in the information processing apparatus 101 is other than Windows, the information processing apparatus 101 may execute the tethering function compatible with the OS included in the information processing apparatus 101. The information processing apparatus 101 can control the SSID and the password of the virtual AP activated by the tethering function. Therefore, the information processing apparatus 101 sets the same SSID and password as the wireless setting information acquired in S108 as the SSID and password of the virtual AP activated by the tethering function. That is, the SSID and the password acquired in S108 are set as the SSID and the password of the AP provided by the information processing apparatus 101. Thereafter, the information processing apparatus 101 transmits a beacon including the SSID or the like as an AP. By this, the printer 102 searching for an AP by the SSID included in the wireless setting information transmitted from the information processing apparatus 101 can discover the information processing apparatus 101 operating as an AP having the SSID. The printer 102 can be connected to the information processing apparatus 101 operating as an AP by the password included in the wireless setting information transmitted to the printer 102.

The printer 102 repeatedly performs the SSID search in S105, and as a result, the printer 102 preferentially detects an AP with high radio field intensity in S110. Here, it is assumed that the radio field intensity of the information processing apparatus 101 in the AP mode is stronger than that of the AP 103. As a result, in S111, using the wireless setting information connected to the AP 103, the printer 102 starts connection to the AP of the SSID detected in S110, that is, the virtual AP of the information processing apparatus 101 in the AP mode.

In S112, the application 351 recovers (or re-creates) the print port based on the information on the printer 102 using the print port used at the time communication with the printer 102 was possible. For example, in a case of Web Services on Devices (hereinafter, WSD), the application 351 needs to search for the printer 102 via the virtual AP to re-create a WSD port. Alternatively, in a case of Transmission Control Protocol/Internet Protocol (hereinafter, TCP/IP), it is necessary to re-create a TCP/IP port by acquiring the IP address of the printer 102.

In S113, the application 351 retransmits the print command transmitted to the printer 102 in S103. In S114, the printer 102 starts printing by receiving the print command in S113. In S115, the printer 102 notifies the application 351 that the printing has been completed. In S116, the application 351 commands the information processing apparatus 101 to display print completion. The print completion display refers to displaying, using the display unit 208 of the information processing apparatus 101, words or a bitmap to notify the user that the printing has been completed. By this, in S117, the information processing apparatus 101 displays print completion to the user.

In S118, the application 351 restores the print port recovered based on the information on the printer 102 in S112 to the print port at the time of communication with the printer 102 via the AP 103. In S118, restoration may be performed using the setting information on the print port stored in S107. In S119, the application 351 disables the AP mode of the information processing apparatus 101. This can also be performed through the API of SoftAP.

FIG. 6 is a flowchart when the application 351 of the system of the present embodiment determines whether the AP mode can be enabled. The present flowchart corresponds to the processing in S106 of FIG. 4 and S206 of FIG. 5, and will be described in more detail. Since FIG. 6A is details of S106, the software execution entity is described as the application 351 in the following description, but the application 351 is executed by the CPU 203.

In S301, the application 351 confirms the network connection using the network interface 211. For example, this confirmation can be performed by referring to the state of a network connection held by the Windows OS or by transmitting a ping to an external network, for example, a predetermined site on the Internet. In S302, the application 351 determines that the information processing apparatus is connected to an external network, for example, the Internet, from the network connection confirmed in S301. In a case where it is determined that there is no Internet connection (S302: No), the processing branches to S309. In S309, the application 351 determines that the AP mode cannot be enabled. On the other hand, in a case where it is determined that there is an Internet connection in S302 (S302: Yes), the processing branches to S303. In the configuration of FIGS. 1A and 1B, even if communication between the printer 102 and the AP 103 is interrupted, since the information processing apparatus 101 is connected to the AP 103, connection to an external network can be confirmed via the AP 103. Note that the external network is a network outside the network of FIGS. 1A and 1B including the information processing apparatus 101, the printer 102, and the AP 103. Specifically, it may be a network outside a router to which the AP 103 is connected. Alternatively, if the information processing apparatus 101 has a communication medium other than the wireless LAN communication medium for connection with the AP 103, such as a wired LAN, a network outside the router connected by it may be used.

Note that steps S301 and S302 are a test for Internet connection, which is a condition necessary for enabling the mobile hotspot function using SoftAP under Windows 10 or 11. Therefore, if an OS other than Windows operating in the information processing apparatus 101 or a specific application can implement a virtual AP equivalent to SoftAP, the Internet connection need not necessarily be a condition. In that case, S301 and S302 can be omitted.

In S303, the application 351 executes acquisition of printer information. This printer information refers to the supported frequency band and the supported encryption method of the network interface 252 of the printer 102. By being acquired when the application 351 and the printer 102 are in a communicable state, or acquired at the time of driver installation, this printer information is stored in the external storage apparatus 206 of the application 351.

In S304, the application 351 determines whether the frequency supported by the printer 102 acquired in S303 and the frequency supported by the information processing apparatus 101 in the AP mode match each other. In a case where the supported frequency of the printer 102 and the supported frequency of the AP mode do not match (S304: No), the processing branches to S309. In S309, the application 351 determines that the AP mode cannot be enabled. In a case where the supported frequency of the printer and the supported frequency of the AP mode match (S304: Yes), the processing branches to S305.

In S305, the application 351 determines whether the encryption method supported by the printer acquired in S303 and the encryption method supported by the AP mode match each other. In a case where the supported encryption method of the printer and the supported encryption method of the AP mode do not match (S305: No), the application 351 determines that the AP mode cannot be enabled in S309. In a case where the supported encryption method of the printer and the supported encryption method of the AP mode match (S305: Yes), the processing branches to S306.

In S306, the application 351 acquires the radio field intensity between the printer 102 and the AP 103. When acquiring this radio field intensity, the application 351 requests information from the printer 102 via the AP 103. In a case where the communication between the printer 102 and the AP 103 is a wireless communication error as in S102 of FIG. 4, the application 351 determines that the radio field intensity is 0% because no response is returned. In a case of not a wireless communication error but a communicable state or an unstable communication situation, the application 351 acquires the radio field intensity from the printer main body because a response is returned.

In S307, the application 351 determines whether the radio field intensity between the printer 102 and the AP 103 acquired in S306 is a certain threshold or less. In a case of determining that the radio field intensity between the printer 102 and the AP 103 is not the certain threshold or less (S307: No), the application 351 determines that the AP mode cannot be enabled in S309 because there is a possibility of a temporary communication error. In a case of determining that the radio field intensity between the printer 102 and the AP 103 is the certain threshold or less (S307: Yes), the processing branches to S308. In S308, the application 351 determines that the AP mode can be enabled.

As a result of the determination of FIG. 6B, S107 is executed following S106 in FIG. 4 if the AP mode can be enabled, and the processing is stopped in S106 if otherwise.

According to the present embodiment described above, in a case where the wireless communication between the printer 102 and the AP 103 is in an error state and the print command from the application 351 is not executed, the determination of the possibility of enabling the AP mode of the information processing apparatus 101 is executed. In a case where it is determined that the AP mode can be enabled, using the AP mode of the information processing apparatus 101, the same SSID and password as those of the AP 103 are set in the virtual AP by the information processing apparatus 101. The printer 102 detects the virtual AP activated in the AP mode and performs wireless connection, and the information processing apparatus 101 and the printer 102 establish wireless communication peer-to-peer. This enables the application 351 to transmit the print command to the printer 102.

Even in a case where the information processing apparatus 101 is communicating with another information processing apparatus using the AP mode, by storing the setting of the wireless connection or the like set immediately before the AP mode is enabled, the AP mode setting can be returned to the setting immediately before the AP mode is enabled. This can also return to the same connection form as that before the execution. Since the SSID and password of the AP to which the information processing apparatus 101 is connected are set to the AP mode, a user operation is not necessary.

### Modification Example

Although a method for setting the same SSID as the AP to the AP mode has been described in the present embodiment, a predetermined unique SSID and password may be stored in the ROM 254 of the printer 102. The printer 102 executes the SSID search in S105 of FIG. 4 based on the unique SSID and password stored in the ROM 254 at the time of the wireless communication error. On the other hand, in S108, by setting, to the AP mode, the unique SSID and password shared with the printer 102 that are stored in advance, the information processing apparatus 101 can start up the virtual AP with the SSID different from that of the AP 103. Since the printer 102 also performs the search based on the unique SSID, the SSID can be detected as in S109 of FIG. 4.

The method for setting the unique SSID and password to the AP mode of the information processing apparatus 101 may be manually executed by the user. Alternatively, the application 351 stored in the external storage apparatus 206 of the information processing apparatus 101 that performs printing or another application may automatically execute the method after detecting the communication failure. The latter configuration enables the user to execute, without operation, the print command by connecting peer-to-peer between the virtual AP started up by the information processing apparatus 101 and the printer.

The wireless setting information acquisition in S107 of FIG. 4 of the present embodiment has been described with the method for acquiring from the ROM 204 of the information processing apparatus 101, but it may have a configuration in which the user manually inputs the password. This makes it possible to execute the present embodiment even in a case where the wireless setting information acquisition is impossible in S107 of FIG. 4. Furthermore, when the AP mode is activated to start up the virtual AP, switching of the connection with the printer from the connection via the AP 103 to the direct connection may be presented to the user by displaying so on the information processing apparatus 101 or the like.

### Second Embodiment

In the present embodiment, the information processing apparatus 101 functions in the AP mode and is simultaneously connected to the AP 103, thereby implementing tethering. Note that the configuration of the communication system is similar to that of the first embodiment. That is, in the present embodiment, the AP mode is enabled in the information processing apparatus 101 of the first embodiment, and is in a state of already functioning as the virtual AP. In the present embodiment, in addition to the information processing apparatus 101, another information processing apparatus using the information processing apparatus 101 as a virtual AP also exists in the communication system. Therefore, the information processing apparatus 101 is called an information processing apparatus A, and the other information processing apparatus is called an information processing apparatus B.

FIG. 5 is a sequence diagram of wireless connection recovery in the case where the information processing apparatus of the present system is using the AP mode. As in FIG. 1A, it is assumed that the AP 103 establishes communication with each of the information processing apparatus A and the printer 102. The SSID of the wireless setting information used when the information processing apparatus A performs wireless communication with the AP 103 is an SSID1, and the password is a PASSWORD1. Thereafter, as in FIG. 1B, it is assumed that communication between the printer 102 and the AP 103 is brought into a wireless communication error state. It is assumed that the information processing apparatus B is performing wireless communication with respect to a virtual AP2 started up by the information processing apparatus A using the AP mode. The SSID of the wireless setting information used in this AP mode is an SSID2, and the password is a PASSWORD2.

S201 to S207 of FIG. 5 is the same processing as S101 to S107 of FIG. 4, and therefore the description will be omitted. Note that in order to commonize the processing in S101 to S107 and S201 to S207, S101 to S107 of FIG. 4 may be executed also in the present embodiment, and thereafter, the application 351 may determine whether or not the AP mode has already been enabled in the information processing apparatus 101. The processing may be configured to branch to S208 if the AP mode has already been enabled, and the processing may be configured to branch to S108 if the AP mode has not been enabled.

In S208, the application 351 acquires the wireless setting information of the AP 103 from the information processing apparatus A. This wireless setting information refers to the SSID1 and the PASSWORD1 of the AP 103. In S209, the application 351 stores (or saves), into the RAM 205 of the information processing apparatus A, the SSID2 and the PASSWORD2 that are set as the wireless setting information of the AP mode of the information processing apparatus A. In S210, the application 351 sets, to the AP mode of the information processing apparatus A, the same SSID1 and the PASSWORD1 as the wireless setting information of the AP 103 acquired in S208, and starts up a virtual AP1.

S211 to S212 are the same as S110 to S111 of FIG. 4. In this process, a connection between the information processing apparatus A and the printer 102 is established.

The information processing apparatus B is disconnected from the virtual AP2 started up in the AP mode by the information processing apparatus A accompanying the change of the AP mode setting of the information processing apparatus A in S210. In S213, the information processing apparatus B performs SSID search based on the SSID2 of the virtual AP2. The information processing apparatus B continues executing the SSID search unless the corresponding SSID is found. S214 to S220 are the same as S112 to S118 of FIG. 4 described above. By the processing from S214 to S220, the information processing apparatus A is connected to the printer 102 to transmit a print command (print job) to the printer 102. Furthermore, the print port for transmitting a print command to the printer 102 is restored to the print port at the time of communication with the printer 102 via the AP 103. By this, when communication between the AP 103 and the printer 102 is restored, the information processing apparatus A is returned to a state where the information processing apparatus A can be connected to the printer 102 via the AP 103.

In S221, the application 351 acquires the SSID2 and the PASSWORD2 that are the same as the wireless setting information used at the time of communicating with the information processing apparatus B stored in S209, and changes the AP mode setting. In S222, by detecting the virtual AP2 set in the AP mode of S221, the information processing apparatus B resumes communication.

In the above manner, according to the present embodiment, the wireless setting information of the virtual AP of the information processing apparatus originally functioning as the virtual AP is replaced with the wireless setting information of the AP with which the printer 102 has been communicating, thereby implementing direct communication with the printer 102. Therefore, even if communication with the printer 102 via the AP 103 is interrupted, communication with the printer 102 can be performed. This can transmit a print job from the information processing apparatus 101 to the printer 102 and can execute printing, even if there is a problem in communication with the printer 102 via the AP 103.

Furthermore, after the direct communication with the printer 102, the function as the virtual AP can be restored by resetting the wireless setting information as the original AP that has been saved.

A modification example of the first embodiment can also be applied to the present embodiment.

### Third Embodiment

The configuration of the communication system is substantially the same as that of the first embodiment. However, in the present embodiment, two APs (AP1 and AP2) are included in the system. In the present embodiment, when communication between the information processing apparatus and the printer connected in the infrastructure mode is no longer possible due to AP replacement or the like, wireless setting of a new AP is performed in the printer via temporary connection using the AP mode of the information processing apparatus.

FIG. 7 is a sequence diagram for performing setting of the AP in the printer via temporary connection using the AP mode when communication between the information processing apparatus and the printer is no longer possible due to replacement of the AP in the present system or the like. As in FIG. 1A, it is assumed that the AP 103 establishes communication with respect to each of the information processing apparatus 101 and the printer 102. Note that in the present embodiment, since there are two APs, the AP 103 that is originally used is called the AP1, and a new AP after replacement is called the AP2. The application 351 stores the SSID1 and the PASSWORD1, which are wireless setting information used when wireless communication with the AP1 is performed, into the ROM 204 that is updatable in the information processing apparatus 101 together with the information on the printer 102. This storing processing is executed when the printer driver is installed or when the application 351 completes printing or the like. The information on this printer 102 is for specifying a target printer and includes information on the print queue 302.

In FIG. 7, the print system 301 and the application 351 are executed by the CPU 203 of the information processing apparatus 101. The processing of the printer 102 is executed by the CPU 255.

Before the sequence of FIG. 7, the user removes the AP1 from the system, for example, by turning off the power, and turns on the power of the AP2 to bring it into a usable state. At this stage, the SSID and password, which are the wireless connection settings of the AP2, are known by the user. Similarly to the first and second embodiments, the print system 301 of FIG. 7 includes functions provided by the OS that are not included in the print system 301 illustrated in FIG. 3, such as reception of manual input, display of a message, and control of communication.

In S401, the user changes the wireless connection setting for the information processing apparatus 101. That is, in S401, the information processing apparatus 101 receives an input for changing the wireless setting information including the SSID and password. For example, there is a case where the user replaces the old router (AP1) with the new router (AP2). Here, it is assumed that the user manually selects the SSID2, which is the SSID of AP2, and inputs the PASSWORD2 as the password.

In S402, the print system 301 of the information processing apparatus 101 performs wireless communication with the AP2. By this, it is assumed that the SSID2 and the PASSWORD2, which are wireless setting information on AP2, are stored in the ROM 204 of the information processing apparatus 101. At this time, since the information processing apparatus 101 is in a state where the wireless communication with the AP1 is lost, it cannot execute transmission of a print command (print job) or the like to the printer 102. Therefore, S403 to S409 are the same processing as S101 to S107 of FIG. 4, and therefore the description will be omitted. Note that in S408, the application 351 executes the processing illustrated in FIG. 6 to determine whether or not the AP mode can be enabled.

Upon storing the setting of the print port in S409, the application 351 acquires the wireless setting information from the information processing apparatus 101 in S410. The wireless setting information mentioned here refers to the SSID2 and the PASSWORD2, which are wireless setting information on AP2. In S411, using the AP mode of the information processing apparatus 101, the application 351 sets, as wireless setting information, the SSID1 and the PASSWORD1 stored in the ROM 204 in the information processing apparatus 101. The AP mode is enabled at this time point, but the AP mode may be disabled once if necessary for resetting the wireless setting information, and then the AP mode may be enabled with new wireless setting information. Of course, if the AP mode can be continued only by resetting of the wireless setting information, the AP mode may be continued. S412 to S413 is the same processing as S110 to S111 of FIG. 4, and therefore detailed description will be omitted. In S413, the information processing apparatus 101 and the printer 102 are connected via the virtual AP of the information processing apparatus 101.

In S414, the application 351 transmits, to the printer 102, the SSID2 and the PASSWORD2, which are wireless setting information on AP2 acquired in S410. Specifically, the application 351 performs setting on the printer by transmitting a managed information base (hereinafter, MIB) indicating an SSID and a password using a simple network management protocol (hereinafter, SNMP). In the present embodiment, use of the SNMP is described, but a configuration of performing communication using another protocol may be adopted.

In S415, the printer 102 disconnects the wireless communication with the virtual AP started up in the AP mode of the information processing apparatus 101 after receiving the wireless setting information in S414. In S416, the printer 102 sets the SSID2 and the PASSWORD2, which are wireless setting information received in S414, as the wireless setting information on the printer 102, and performs wireless communication with the AP2 using them. In S417, the application 351 performs communication confirmation with the printer 102. If the communication with the printer 102 is successful, the connection between the information processing apparatus 101 and the printer 102 via the AP2 is established. Here, it is assumed that communication with the printer 102 is successfully performed via the AP2. S418 to S423 is the same processing as S112 to S117 of FIG. 4, and therefore the description will be omitted. However, while the information processing apparatus 101 and the printer 102 are connected not via the AP 103 in the first embodiment, the present embodiment is different from the first embodiment in that the information processing apparatus 101 and the printer 102 are connected via the AP2. In S424, the application 351 disables the AP mode of the information processing apparatus 101. Note that the AP mode may be disabled when it is confirmed in S417 that the communication with the printer 102 is possible.

According to the present embodiment described above, in a case where the AP to which the information processing apparatus 101 is connected is replaced, the SSID and password of the AP used when the printer 102 can be connected are stored. By doing this, it is possible to set the same SSID and password also in the AP mode of the information processing apparatus 101, and the virtual AP started up in the AP mode and the printer 102 can perform wireless communication peer-to-peer. By transmitting, to the printer 102, the wireless setting information of the AP to which the information processing apparatus 101 is connected, it is possible for the printer 102 to be connected by wireless communication to the AP to which the information processing apparatus 101 is connected, based on the received wireless setting information. This enables the information processing apparatus 101 and the printer 102 to communicate with each other via the new AP, and enables a print command to be transmitted by resetting the print port. Since the wireless setting information is stored in the ROM 254 of the printer 102 even when the main body power source of the printer 102 is turned off, the printer 102 is connected to the new AP even at the time of reactivation and no wireless communication error occurs.

Although the present embodiment assumes replacement of APs, the present embodiment can also be applied to interruption of communication with the AP due to movement of the information processing apparatus. Many recent information processing apparatuses can be physically carried. Therefore, it is also assumed that a physical distance between the information processing apparatus 101 and the AP 103 increases. As a solution to communication interruption in such a case, the position information acquisition apparatus 212 of the information processing apparatus 101 is used to store the position information into the ROM 204 of the information processing apparatus 101 when in the communicable state with the printer 102. This may be done, for example, periodically. Then, by comparing the stored position information with the position information when the wireless communication error occurs, in a case where it is determined that the physical distance exceeds a certain threshold, switching of the communication partner of the printer by the first to third embodiments is not executed. On the other hand, in a case where it is determined that the distance between the position of the stored position information and the position when the wireless communication error occurs is a physical distance within a certain threshold, switching of the communication partner of the printer by the first to third embodiments is executed. This can determine that the physical distance between the information processing apparatus and the AP is great and it becomes possible not to execute the present embodiment more than necessary.

### Other Embodiments

In the above description, a form has been described in which the information processing apparatus 101 starts the operation in the AP mode by the tethering function based on the occurrence of an error in communication of a print execution command. However, a trigger of the processing in which the information processing apparatus 101 starts the operation in the AP mode by the tethering function is not limited to the occurrence of an error in communication of a print execution command. The trigger may be occurrence of an error in other communication. The trigger may be, for example, that the printer 102 has not been found by the search executed by the information processing apparatus 101. Specifically, the information processing apparatus 101 establishes a direct connection with the printer 102 operating in a connection setting mode, and transmits, to the printer 102, wireless setting information for connection with an external AP. The printer 102 that has received the wireless setting information attempts connection with the AP using the wireless setting information. Then, after transmitting the wireless setting information, the information processing apparatus 101 re-establishes the connection with the external AP to which the information processing apparatus 101 has been connected before establishing the direct connection with the printer 102. Then, the information processing apparatus 101 searches for the printer 102 connected to the network formed by the external AP via the connection with the external AP. Then, in a case where the printer 102 is not found by the search, the information processing apparatus 101 may start the operation as an AP mode connectable by the same SSID or password as the SSID or password included in the wireless setting information transmitted to the printer 102. In a case where the connection with the external AP using the wireless setting information by the printer 102 has failed, or the connection with the external AP using the wireless setting information by the printer 102 has succeeded but the connection is lost, the printer 102 re-attempts the connection with the AP using the wireless setting information. Therefore, by the information processing apparatus 101 starting the operation in the AP mode as described above, the connection between the printer 102 and the information processing apparatus 101 is established.

In the above description, a form has been described in which the information processing apparatus 101 starts the operation in the AP mode connectable by the same SSID or password as the SSID or password included in the connection information transmitted to the printer by the tethering function. However, the information processing apparatus 101 may start the operation in the AP mode connectable by another SSID or password by the tethering function. Specifically, for example, the information processing apparatus 101 may notify the printer 102 of the other SSID or password. The information processing apparatus 101 may start the operation in the AP mode connectable by the other SSID or password based on occurrence of a trigger of processing of starting the operation in the AP mode by the tethering function. Then, in a case where the connection with the external AP is lost, the printer 102 may attempt connection with the AP by the other SSID or password notified from the information processing apparatus 101. By this, in the case where the connection with the external AP is lost, the printer 102 is connected to the information processing apparatus 101 operating in the AP mode connectable by the other SSID or password.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-022493, filed February 14, 2025 which is hereby incorporated by reference herein in its entirety.

What is claimed is:

1. A control method for an information processing apparatus, the control method comprising:
determining whether an error has occurred in communication between the information processing apparatus and a communication apparatus; and
executing predetermined processing for causing the information processing apparatus to start an operation as a first access point based on a determination that an error has occurred in the communication.

2. The control method according to claim 1, wherein
the information processing apparatus includes a predetermined application program, and
the predetermined processing includes processing of executing, by the predetermined application program, an API for executing a tethering function included in the information processing apparatus.

3. The control method according to claim 1 further comprising
acquiring connection information for connecting to a second access point, which is an access point to which the information processing apparatus is connected and which is an access point external to the information processing apparatus, wherein
the predetermined processing includes processing of controlling connection information for connecting to the first access point to be the same as the connection information for connecting to the second access point.

4. The control method according to claim 1, wherein
the predetermined processing includes processing of controlling connection information for connecting to the first access point to be unique connection information stored in advance in the communication apparatus.

5. The control method according to claim 1 further comprising
determining whether or not the information processing apparatus is connected to the Internet, wherein
the predetermined processing is executed based on a determination that an error has occurred in the communication and a determination that the information processing apparatus is connected to the Internet, and
even when it is determined that an error has occurred in the communication, the predetermined processing is not executed in a case where it is determined that the information processing apparatus is connected to the Internet.

6. The control method according to claim 1 further comprising
determining whether or not the information processing apparatus is connected to the Internet, wherein
the predetermined processing is executed based on a determination that an error has occurred in the communication and a determination that the information processing apparatus is connected to the Internet, and
even when it is determined that an error has occurred in the communication, the predetermined processing is not executed in a case where it is determined that the information processing apparatus is not connected to the Internet.

7. The control method according to claim 1 further comprising
determining whether or not a frequency supported by the first access point and a frequency supported by the communication apparatus match, wherein
the predetermined processing is executed based on a determination that an error has occurred in the communication and a determination that the frequency supported by the first access point and the frequency supported by the communication apparatus match, and
even when it is determined that an error has occurred in the communication, the predetermined processing is not executed in a case where it is determined that the frequency supported by the first access point and the frequency supported by the communication apparatus do not match.

8. The control method according to claim 1 further comprising
determining whether or not an encryption method supported by the first access point and an encryption method supported by the communication apparatus match, wherein
the predetermined processing is executed based on a determination that an error has occurred in the communication and a determination that the encryption method supported by the first access point and the encryption method supported by the communication apparatus match, and
even when it is determined that an error has occurred in the communication, the predetermined processing is not executed in a case where it is determined that the encryption method supported by the first access point and the encryption method supported by the communication apparatus do not match.

9. The control method according to claim 1 further comprising
determining whether or not a radio field intensity between the second access point and the communication apparatus is a threshold or less, wherein
the predetermined processing is executed based on a determination that an error has occurred in the communication and a determination that the radio field intensity is not the threshold or less, and
even when it is determined that an error has occurred in the communication, the predetermined processing is not executed in a case where it is determined that the radio field intensity is the threshold or less.

10. The control method according to claim 1, wherein
the communication between the information processing apparatus and the communication apparatus is communication by which the information processing apparatus transmits a print command to the communication apparatus.

11. The control method according to claim 10, wherein
the communication by which the information processing apparatus transmits the print command to the communication apparatus is executed again in a case where a connection between the information processing apparatus operating as the first access point and the communication apparatus is established by execution of the predetermined processing.

12. The control method according to claim 11 further comprising
generating a print port based on information on the communication apparatus in a case where the connection between the information processing apparatus operating as the first access point and the communication apparatus is established by execution of the predetermined processing, wherein
after the print port is generated, the communication by which the information processing apparatus transmits the print command to the communication apparatus is executed again.

13. The control method according to claim 12, wherein
processing of generating the print port is processing of creating a Web Services on Devices port by searching for the communication apparatus via the first access point or processing of creating a Transmission Control Protocol/Internet Protocol port by acquiring an IP address of the communication apparatus.

14. The control method according to claim 12 further comprising
restoring a print port used in communication with the communication apparatus before the predetermined processing is executed after the communication by which the information processing apparatus transmits the print command to the communication apparatus is executed again.

15. The control method according to claim 1 further comprising
executing processing for disabling the first access point after the communication by which the information processing apparatus transmits a print command to the communication apparatus is executed again.

16. An information processing apparatus comprising:
at least one memory storing instructions; and
at least one processor that is in communication with the at least one memory and that, when executing the instructions, cooperates with the at least one memory to execute processing, the processing including
determining whether an error has occurred in communication between the information processing apparatus and a communication apparatus, and
executing predetermined processing for causing the information processing apparatus to start an operation as a first access point based on a determination that an error has occurred in the communication.

17. A non-transitory computer-readable storage medium storing a program for causing a computer of an information processing apparatus to
determine whether an error has occurred in communication between the information processing apparatus and a communication apparatus, and
execute predetermined processing for causing the information processing apparatus to start an operation as a first access point based on a determination that an error has occurred in the communication.
